(19) United States
(12) Patent Application Publication
(10) Pub. No.: US 2025/0058835 A1
(43) Pub. Date: Feb. 20, 2025

(54) MODULAR CONTAINER SYSTEM FOR DELIVERY VEHICLES

(71) Applicant: Ford Global Technologies, LLC, Dearborn, MI (US)

(72) Inventors: John Randolf Vincent, Livonia, MI (US); Kurt Michael Lundeen, Novi, MI (US); Sam Hoff, Hazel Park, MI (US); Timothy Mark Feldkamp, Ann Arbor, MI (US); Yifan Chen, Ann Arbor, MI (US); Smruti Panigrahi, Novi, MI (US); Kevin Hwang, Northville, MI (US)

(73) Assignee: Ford Global Technologies, LLC, Dearborn, MI (US)

(21) Appl. No.: 18/451,248

(22) Filed: Aug. 17, 2023

(51) Int. Cl. B62D 33/02

(52) U.S. Cl. CPC B62D 33/0207

(57) ABSTRACT

A container configured to be removably attached into a delivery vehicle is disclosed. The container may include a base, a first sidewall, a second sidewall and a third sidewall. Each of the first sidewall, the second sidewall and third sidewall may be disposed perpendicular to the base. The container may further include a slot disposed on the first sidewall, the second sidewall and the third sidewall. The container may additionally include a first power and data interface disposed on the third sidewall, and a frame configured to be removably inserted into the container via the slot. The frame may include a second power and data interface configured to couple with the first power and data interface, and a plurality of grids configured to secure a plurality of motorized tiles.

### FIELD

The present disclosure relates to a modular container system for delivery vehicles and more particularly to a customizable and removable modular container system including a plurality of grids configured to secure motorized tiles of a delivery vehicle.

### BACKGROUND

With the continued growth of internet-based commerce, package delivery is increasingly used to deliver goods to customers. Specifically in the US, e-commerce business is expected to continue to grow in the years to come.

Unprecedented growth is received favorably by e-commerce companies; however the rapid growth also leads to operational challenges in the supply chain. E-commerce companies and their delivery partners deliver an ever-increasing number of packages per day, while trying to limit spend on resources (e.g., labor, etc.) and reduce delivery time.

Various approaches are currently used to optimize the process of loading/unloading delivery packages to/from a delivery vehicle, and the process of delivering packages to respective delivery locations. For example, E-commerce companies load packages with similar delivery addresses in proximity to each other in a delivery vehicle to gain efficiency in unloading packages. However, in many instances, the packages to be loaded/unloaded are of varying sizes, and hence vehicle operators and/or delivery partners face inconvenience in optimally loading and unloading such packages to/from a delivery vehicle.

Conventional systems for package loading/unloading provide limited scope for customization, and hence do not facilitate optimal loading/unloading in all instances. Thus, there exists a need for a flexible and customizable package loading/unloading system.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example delivery vehicle in which techniques and structures for providing the systems and methods disclosed herein may be implemented.

FIG. 2 depicts an example container in accordance with the present disclosure.

FIG. 3 depicts an example frame in accordance with the present disclosure.

FIG. 4 depicts an example usage of the container of FIG. 2 and the frame of FIG. 3 in accordance with the present disclosure.

FIG. 5 depicts another example usage of the container of FIG. 2 and the frame of FIG. 3 in accordance with the present disclosure.

FIGS. 6A and 6B depict example orientations of the container of FIG. 2 in a vehicle cargo space in accordance with the present disclosure.

FIG. 7 depicts a first example base of a bin in accordance with the present disclosure.

FIG. 8 depicts a second example base of a bin in accordance with the present disclosure.

FIG. 9 depicts a flow diagram of a method for installing a container in a delivery vehicle in accordance with the present disclosure.

### DETAILED DESCRIPTION

### Overview

The present disclosure describes a container configured to be removably attached to a delivery vehicle. The container may be shaped as a cube or a cuboid, and may have customizable dimensions. The container may be attached to the delivery vehicle via a container base bolted to a vehicle cargo bed, and/or via container sidewalls bolted to vehicle sidewalls. The container may further include a back wall that may include a container power and data interface. The container power and data interface may be configured to electrically and communicatively couple with a vehicle power and data interface, and obtain power and data/command signals from the delivery vehicle.

In some aspects, each of the container sidewalls and the back wall may include one or more slots into which one or more container frames (or frames) may be inserted. Similar to the container dimensions, frame dimensions and type may also be customizable. Each frame may include a frame power and data interface that may electrically and communicatively couple with the container power and data interface to obtain power and data/command signals from the delivery vehicle. Each frame may further include a plurality of grids into which a plurality of motorized tiles may be secured. In some aspects, each motorized tile may be configured house or secure a bin (or a delivery package) via a bin base.

Each grid may include a grid power and data interface that may obtain power and command signals from the frame power and data interface. The grid may activate the motorized tile secured on the grid via the power obtained from the grid power and data interface, and control motion of tile wheels and/or tile gates based on the obtained command signals.

In additional aspects, the bin and the bin base may be a single integrated structure that may be formed, for example, of lightweight plastic. In some aspects, the bin base may include V-shaped grooves on base periphery that may enable bin movement on the motorized tile, e.g., when the bin moves past the tile gates. The bin base may further include geometric features or patterns that may be formed at a base bottom surface that enables the bin base to conveniently move on the tile wheels.

In other aspects, the bin and the bin base may be separate structures that may be made of same or different materials. In this case, the bin base may include base sidewalls into which a bin bottom portion may be inserted, to secure the bin into the bin base. In further aspects, one or more base sidewalls may be configured to be folded or removed to enable two or more bin bases to be combined to house a large-sized bin.

The present disclosure discloses a customizable and removable container that may be attached to a delivery vehicle. The user may customize the container and/or frame dimensions and type based on user's requirements and count and sizes of bins/delivery packages to be delivered by the delivery vehicle, thereby enhancing user convenience. Further, lightweight bin and bin base design facilitates in enhancing bin loading/unloading efficiency and reducing vehicle energy consumption during transit.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

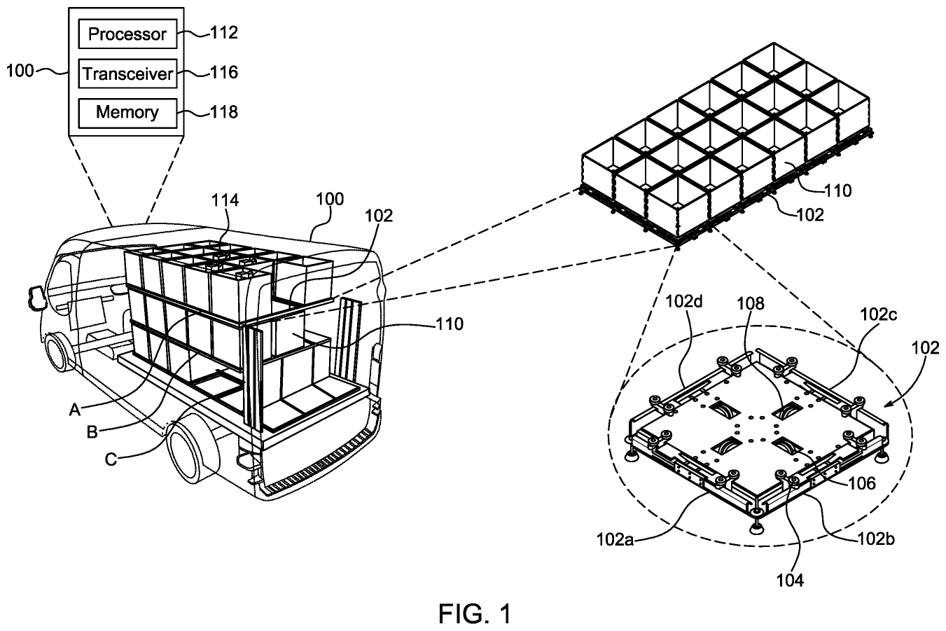

FIG. 1 depicts an example delivery vehicle 100 (or vehicle 100) in which techniques and structures for providing the systems and methods disclosed herein may be implemented. The vehicle 100 may be a truck, a van (including walk-in vans), a truck trailer, and/or the like. In some aspects, the vehicle 100 may be an autonomous vehicle. In other aspects, a driver (not shown) may operate the vehicle 100. Further, the vehicle 100 may include any powertrain such as, for example, a gasoline engine, one or more electrically-actuated motor(s), a hybrid system, etc.

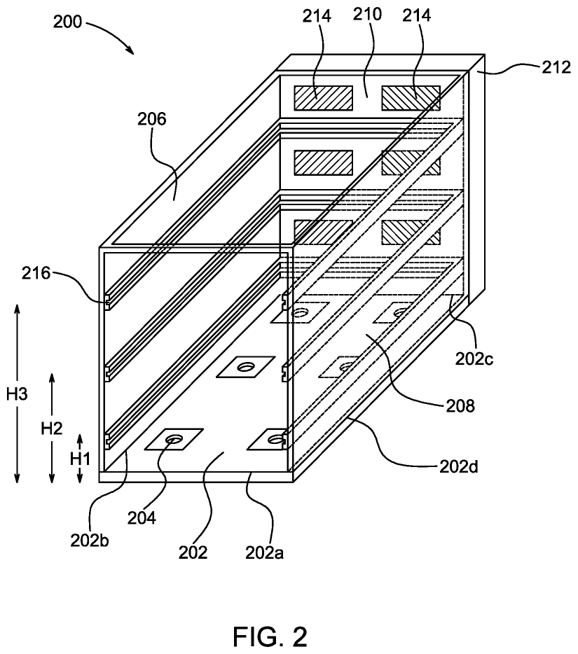

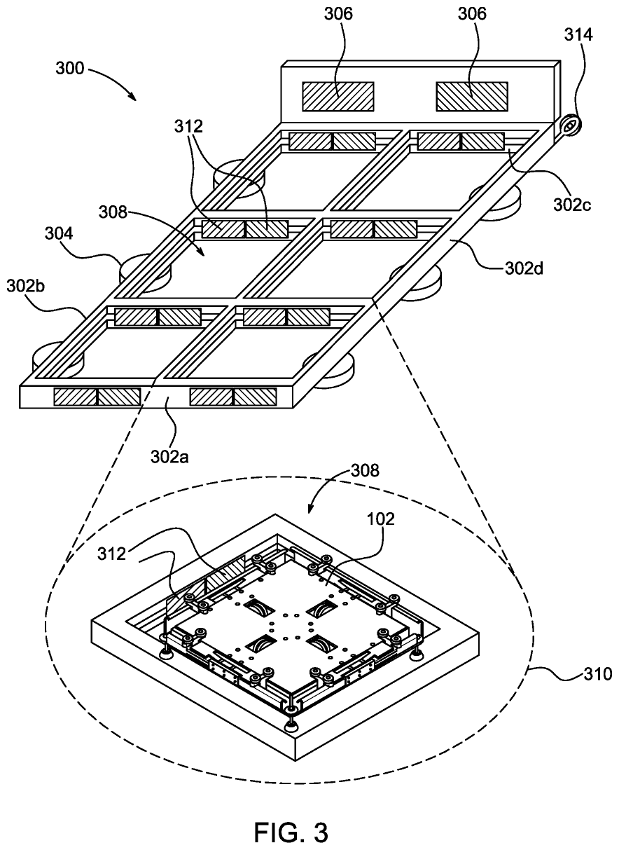

The vehicle 100 may be configured to be removably attached with a container (shown as container 200 in FIG. 2) in a vehicle interior portion. The container may include one or more frames (shown as frame 300 in FIG. 3) including a plurality of grids (shown as grids 308 in FIG. 3). In some aspects, each frame may be configured to house/secure a plurality of motorized tiles 102. Specifically, each grid of a frame may secure one motorized tile 102. In the exemplary aspect depicted in FIG. 1, the container includes three frames or arrays of motorized tile 102 (an upper array “A”, a middle array “B” and a lower array “C”), which are disposed one over the other in the vehicle interior portion. Although FIG. 1 depicts three frames/arrays, the present disclosure is not limited to such an arrangement. The container may include more or less count of frames. Structural details of the container and the frames are described later below in detail in conjunction with FIGS. 2 and 3.

In an exemplary aspect, each motorized tile 102 may be rectangular or square in shape (as shown in FIG. 1), and may include four edges 102a, 102b, 102c and 102d. Each edge 102a-d may include one or more gates 104 that may be configured to move/slide along the lengths of respective edges 102a-d. Each motorized tile 102 may further include a first set of wheels 106 that may be configured to rotate in one direction (e.g., a first direction) and a second set of wheels 108 that may be configured to rotate in another direction (e.g., a second direction). In some aspects, the first direction may be perpendicular to the second direction. Further, in an exemplary aspect, a rotation speed of each wheel 106, 108 may be same.

Each motorized tile 102 may be configured to hold/store a bin 110, and/or move the bin 110 from one location to another in the vehicle interior portion by using the wheels 106 or 108 based on a command signal obtained from a vehicle processor 112 (or processor 112). Specifically, responsive to receiving the command signal from the processor 112, one set of wheels from the first and second sets of wheels 106, 108 may rotate at a preset wheel speed, and the gates 104 on respective edges 102a-d may “slide away” from each other to position at the corners of the motorized tile 102. In this arrangement, when a bin (e.g., the bin 110) is placed on the motorized tile 102 or comes in contact with the moving wheels 106 or 108, the bin 110 may move on the motorized tile 102. For example, if the second wheels 108 are rotating in a clockwise direction and the bin 110 comes in contact with the rotating second wheels 108, the bin 110 may slide or move from the edge 102a towards the edge 102c. In this manner, responsive to receiving the command signal from the processor 112, the motorized tile 102 may enable bin movement on the motorized tile 102.

In further aspects, responsive to receiving another command signal from the processor 112, the motorized tile 102 may stop wheel movement (e.g., stop second wheel movement) and cause the gates 104 on respective edges 102a-d to slide towards each other. In this arrangement, the bin 110 may be stored or secured on the motorized tile 102. Further, in this arrangement, the gates 104 may slide towards each other to prevent bin slippage from the motorized tile 102. Such an arrangement may be used when the bin 110 may be required to be transported or securely held in the vehicle 100.

In some aspects, each motorized tile 102 obtain power (to operate the wheels 106, 108 and/or the gates 104) and command signals from the processor 112 via a grid power and data interface (shown as grid power and data interface 312 in FIG. 3) that may be disposed at the grid on which the motorized tile 102 may be secured. The grid in turn may obtain power and/or data/signals from the container via a frame power and data interface (shown as frame power and data interface 306 in FIG. 3) that may disposed on the frame and a container power and data interface (shown as container power and data interface 214 in FIG. 2) that may be disposed on the container. The container power and data interface may obtain power and/or data/signals from the vehicle 100. In this manner, the container enables powering and operation of each motorized tile 102 based on power and command signals obtained from the vehicle 100.

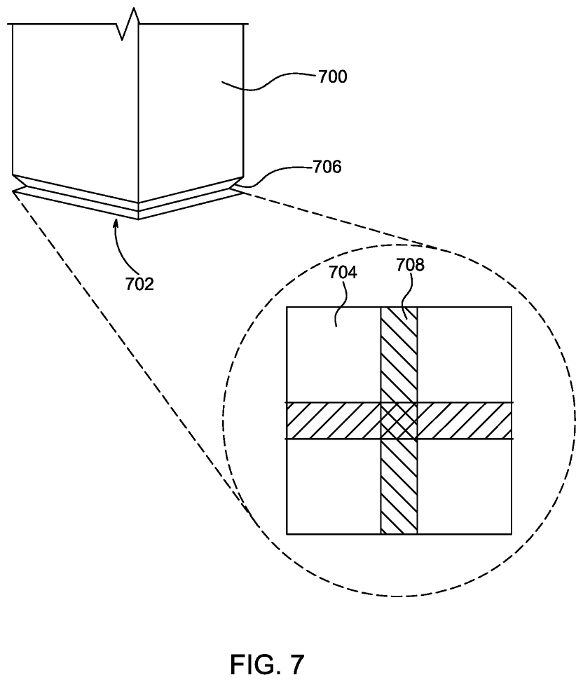

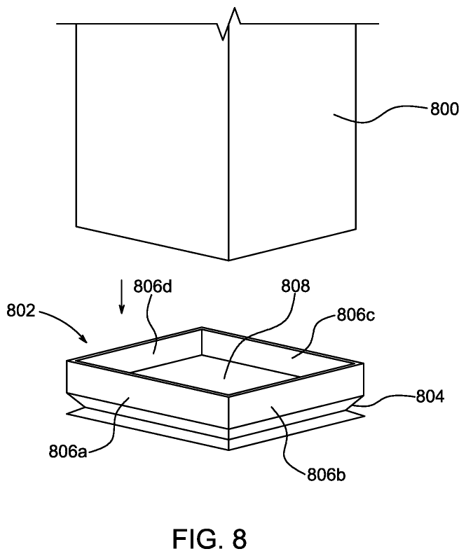

In some aspects, a bin (e.g., the bin 110) may be secured on a motorized tile (e.g., the motorized tile 102) via a bin base (shown as base 702 in FIG. 7 and base 802 in FIG. 8). The bin base may be an integrated part of the bin body, and may be separate from the bin body. Bin base structural details are described later in detail below in conjunction with FIGS. 7 and 8.

In some aspects, each bin 110 may be configured to hold one or more packages 114. In an exemplary aspect, location of each bin in the vehicle 100 and allocation of each package in each bin may be optimally pre-planned or pre-set such that unloading of each package from the vehicle 100 may be convenient (e.g., when the vehicle 100 reaches a package delivery location). In some aspects, information associated with allocation of each package in each bin and location of each bin in the vehicle 100 may be received by a vehicle transceiver 116 (or transceiver 116) from a server (not shown) via one or more network(s).

The network(s) described above may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In an exemplary aspect, the server described above may be associated with an E-commerce firm or a delivery partner that may remotely monitor and/or control movement of a plurality of vehicles operating as part of a vehicle fleet (including the vehicle 100), loading/unloading operation for each vehicle in a warehouse or during transit, and/or the like. The server may transmit the information described above at a predefined frequency to the transceiver 116 during vehicle transit on a delivery route, or when the vehicle 100 commences the delivery route from the warehouse. Responsive to receiving the information from the server, the transceiver 116 may send the information to a vehicle memory 118 (or memory 118) for storage purpose.

The processor 112 may be configured to obtain the information from the memory 118 during transit on the delivery route, and transmit command signals (via the grid, frame and container power and data interfaces described above) to activate movement of one or more motorized tiles 102 and control bin movement in the vehicle interior portion based on the obtained information. For example, when the vehicle 100 reaches a delivery location associated with a specific package, the processor 112 may activate one or more motorized tiles 102 to enable movement of a bin containing the specific package from its storage location in the vehicle 100 (as determined by using the information obtained from the server) to a package pick-up zone/area in the vehicle 100 from where a vehicle operator or a drone may pick the package for last-mile delivery.

The processor 112, as described above, may be disposed in communication with one or more memory devices disposed in communication with the respective computing systems (e.g., the memory 118 and/or one or more external databases not shown in FIG. 1). The processor 112 may utilize the memory 118 to store programs in code and/or to store data for performing aspects in accordance with the disclosure. The memory 118 may be a non-transitory computer-readable storage medium or memory storing delivery package management program code or instructions. The memory 118 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

Although the description above describes an aspect where the processor 112 controls bin movement within the vehicle 100 by activating one or more motorized tiles 102, in some aspects, the activation of the motorized tiles 102 and bin movement may be controlled remotely by the server. Further, although the description above describes an aspect where the packages 114 are disposed/stored in the bins 110, in some aspects, the packages 114 may also be disposed on the motorized tiles 102, a drawer in the container, and/or a vehicle cargo bed, without departing from the present disclosure scope.

Structural details and usage of the removable container including the frames/grids that house the plurality of motorized tiles 102 are described below in conjunction with FIGS. 2-5, 6A and 6B.

The vehicle 100 and the vehicle operator implement and/or perform operations, as described here in the present disclosure, in accordance with the owner manual and safety guidelines.

FIG. 2 depicts an example container 200 in accordance with the present disclosure. The container 200 may be same as the container described above in conjunction with FIG. 1. While describing FIG. 2, references will be made to FIGS. 3-5, 6A and 6B.

The container 200 may be shaped as a hollow cube or cuboid that may be removably installed in a vehicle cargo space of the vehicle 100. The container 200 may include a base 202 that may be made of material such as aluminum, steel, iron, and/or the like. The base 202 may be shaped as a rectangle (or square), and may include a first base edge 202a, a second base edge 202b, a third base edge 202c and a fourth base edge 202d. The first and third base edges 202a, 202c may be perpendicular to the second and fourth base edges 202b, 202d. Further, the first and third base edges 202a. 202c may be parallel to each other. Base dimensions (i.e., dimensions of each base edge) may be customizable based on vehicle dimensions and user requirements.

The container 200 may be configured to be removably attached to a vehicle cargo bed via the base 202. Specifically, in some aspects, the base 202 may include one or more attachment mechanism 204 using which the container 200 may be attached to the vehicle cargo bed. The attachment mechanism 204 may be, for example, bolts, nuts, screws, etc.

The container 200 may further include sidewalls (a first sidewall 206 and a second sidewall 208), a back wall 210 (or a third wall) and a top wall (not shown in FIG. 2). In some aspects, the container 200 may not include a top wall. Each sidewall 206, 208 and the back wall 210 may be rectangular or square in shape, and their respective dimensions may be customizable based on vehicle dimensions and user's requirements. For example, heights of the first and second sidewalls 206, 208 and the back wall 210 may be equivalent to or less than a vehicle cargo space height.

The first sidewall 206, the second sidewall 208 and the back wall 210 may be disposed perpendicular to the base 202. Stated another way, planes of the first and second sidewalls 206, 208 and the back wall 210 may be disposed perpendicular to a plane of the base 202 (or “base plane”). Further, planes of the first and second sidewalls 206, 208 may be perpendicular to a back wall plane. Furthermore, the first and second sidewalls 206, 208 may be disposed parallel to each other, as shown in FIG. 2.

In some aspects, the back wall 210 may be attached to a container control panel 212 including one or more batteries, power electronics, transceivers, etc. The control panel 212 may be attached to a vehicle wall (not shown) in proximity to a driver sitting area. Further, the control panel 212 may be attached to a vehicle power and data interface (not shown) through which the control panel 212 may obtain power (e.g., from vehicle batteries) and command signals from the vehicle 100 (specifically from the processor 112). In some aspects, the back wall 210 may include one or more container power and data interfaces 214 (or first power and data interfaces 214) that may be configured to couple with the vehicle power and data interface, and obtain power and command signals from the vehicle power and data interface via the control panel 212.

In some aspects, the first sidewall 206 and/or the second sidewall 208 may include one or more attachment mechanisms (not shown, similar to the attachment mechanism 204) using which the first and/or the second sidewalls 206, 208 may be attached to vehicle sidewalls. The attachment mechanisms disposed on the first and/or the second sidewalls 206, 208 may provide additional structural integrity to the attachment between the container 200 and the vehicle 100.

The container 200 may further include one or more elongated slots 216 (or slots 216) that may be disposed or formed on the first and second sidewalls 206, 208 and the back wall 210. The slots 216 may be disposed at different distances/heights from the base 202, and a count of slots in the container 200 may be based on container dimensions, vehicle dimensions and/or user requirements. In the exemplary aspect depicted in FIG. 2, the container 200 is shown to include three slots that are disposed at heights “H1”, “H2” and “H3” above the base 202. The present disclosure is not limited to the example aspect depicted in FIG. 2, and the container 200 may include more or less count of slots at different heights, without departing from the present disclosure scope.

Each slot 216 may be a single/integrated slot disposed through a first sidewall length, a back wall length, and a second sidewall length. Further, each slot 216 (specifically a slot longitudinal axis) may be disposed parallel to the base plane. In some aspects, each slot 216 may be configured to receive a container frame, as described below.

The container 200 may further include one or more container frames 300 (or frames 300), as shown in FIG. 3. The frames 300 may be configured to be inserted into the container 200 via the slots 216 (e.g., when the container 200 may be attached to the vehicle cargo bed). As shown in FIG. 3, the frame 300 may have a shape that complements the container shape. Specifically, the frame 300 may be rectangular (or square) in shape if the container 200 is shaped as a cuboid (or cube). Frame dimensions may be based on the dimensions of the first and second sidewalls 206, 208 and the back wall 210.

The frame 300 may include a first frame edge 302a, a second frame edge 302b, a third frame edge 302c, and a fourth frame edge 302d. The first frame edge 302a and the third frame edge 302c may be perpendicular to the second frame edge 302b and the fourth frame edge 302d. Further, the first and third frame edges 302a, 302c may be parallel to each other. In an exemplary aspect, lengths of the second and fourth frame edges 302b, 302d may be equivalent to lengths of the first and second sidewalls 206, 208 or a length of the slot 216 in the first and second sidewalls 206, 208. Further, a length of the third frame edge 302c (or the first frame edge 302a) may be equivalent to a back wall length or the length of the slot 216 in the back wall 210.

The frame 300 may further include one or more rollers 304 that may be disposed at the second and fourth frame edges 302b, 302d. The frame 300 may be configured to be inserted/slid into the slot 216 via the rollers 304. Based on the count of the slots 216 in the container 200, multiple frames 300 may be inserted/slid into the container 200 simultaneously. For example, if the container 200 includes three slots (as depicted in FIG. 2), three frames may be inserted into the container 200 via the slots 216 using respective rollers.

The frame 300 may further include a frame power and data interface 306 (or second frame power and data interface 306) that may be disposed at the third frame edge 302c or a frame wall attached to the third frame edge 302c. The second power and data interface 306 may be configured to obtain power and data/signals from the first power and data interface 214, when the frame 300 may be inserted into the slot 216 and the third frame edge 302c touches the back wall 210. Specifically, when a user or a robot inserts the frame 300 into the slot 216, the second power and data interface 306 may electrically and communicatively couple with the first power and data interface 214 when the third frame edge 302c touches the back wall 210 (or is in proximity to the back wall 210), to enable the second power and data interface 306 to obtain power and data/signals from the first power and data interface 214. In this manner, the second power and data interface 306 obtains power and signals from the vehicle 100 via the first power and data interface 214.

The frame 300 may further include a plurality of grids 308 that may be configured to house/secure the plurality of motorized tiles 102. Specifically, each grid 308 may be configured to secure one motorized tile 102, as shown in view 310 of FIG. 3. In some aspects, each frame 300 may include grids of same sizes, and hence may be configured to secure motorized tiles of same sizes. As described above in conjunction with FIG. 1, each motorized tile 102 may be configured to secure a bin (e.g., the bin 110), which itself may store the package(s) 114. When the user desires to store bins (and/or packages) of different sizes in the vehicle 100, the user may insert frames with different-sized grids into the different slots 216. For example, the user may insert a frame with small-sized grids in the slot 216 that may be disposed at the height “H3” above the base 202, a frame with medium-sized grids in the slot 216 that may be disposed at the height “H2” above the base 202, and a frame with large-sized grids in the slot 216 that may be disposed at the height “H1” above the base 202. Each grid (small, medium or large) may be configured to secure a similar sized motorized tile (small, medium or large), and hence similar sized bin/package (small, medium or large).

A person ordinarily skilled in the art may appreciate that since the frames 300 disposed at different heights (H1, H2, and H3) have same dimensions, in the example described above, the frame with small-sized grids may include a large count of grids and hence may be configured to secure a large count of small-sized bins/packages on respective motorized tiles. Similarly, the frame with medium-sized grids may include a small count of grids and hence may be configured to secure a small count of medium-sized bins/packages on respective motorized tiles. The frame with large-sized grids may include the smallest count of grids and hence may be configured to secure smallest count of large-sized bins/packages on respective motorized tiles.

In some aspects, each grid 308 may include a grid power and data interface 312 (or third power and data interface 312) that may be configured to obtain power and signals from the second power and data interface 306, thereby powering the motorized tile 102 disposed on the grid 308 and/or controlling motorized tile operation (e.g., activation of the wheels 106, 108 and/or the gates 104). In this manner, the vehicle 100 (or the processor 112) may activate and/or control motorized tile operation via the vehicle power and data interface, and the first, second and third power and data interfaces 214, 306 and 312.

In further aspects, the vehicle 100/container 200 may be configured to conserve vehicle/container power or energy when one or more grids 308 or the motorized tiles 102 may not be in use. In this case, the processor 112 may deactivate power distribution to the grid/motorized tile that may not be in use via the vehicle power and data interface and the first, second and third power and data interfaces 214, 306 and 312. In some aspects, the processor 122 may deactivate the power distribution based on user inputs (obtained via a user device or a vehicle infotainment system, not shown), or may deactivate the power distribution autonomously based on inputs obtained from one or more vehicle and/or container sensors, e.g., vehicle interior cameras, weight sensors, and/or the like.

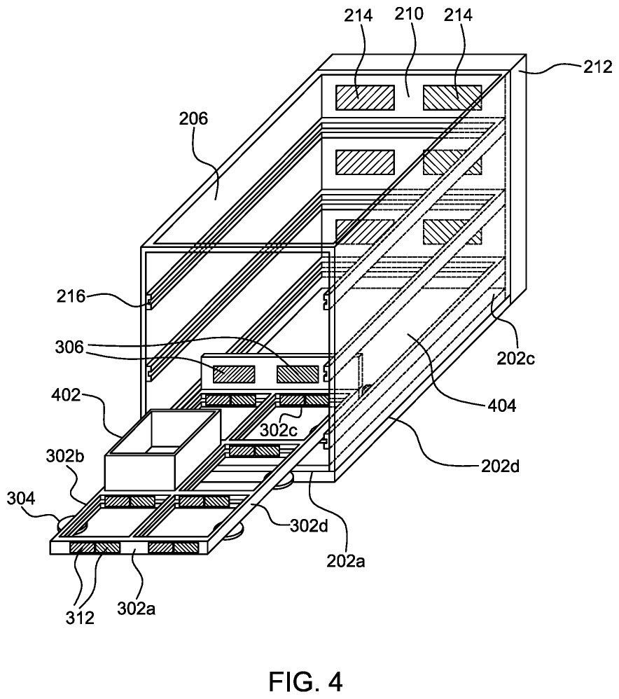

In operation, the user may customize (or order to customize) dimensions of the first and second sidewalls 206, 208 and/or the back wall 210 based on vehicle dimensions or user requirements. The user may further select appropriate frames 300 (e.g., frames with different-sized grids based on bin/package dimensions required to be delivered by the vehicle 100) to be installed or inserted into the slots 216. Responsive to customizing the container 200 (or obtaining the customized container 200 based on user requirements/vehicle dimensions), the user may attach the container 200 to the vehicle cargo bed via the attachment mechanism 204. The user may then insert the selected frame(s) 300 into the slot(s) 216. The user may further couple one or more motorized tiles into the grid(s) 308 and place a bin 402 (or a package) required to be loaded into the vehicle 100 on respective motorized tile. An example view of container usage with the bin 402 placed on the grid 308 (specifically on a motorized tile secured in the grid 308) is depicted in FIG. 4.

Although the description above describes an aspect where the container 200 includes one or more frames 300 (e.g., three frames) and each frame includes the grids 308 to secure the motorized tiles 102, in some aspects, the container 200 may additionally include a drawer or tray 404 that may be configured to be inserted into one of the three slots 216 described above or into a “fourth” slot that may be disposed in proximity to the base 202. The tray 404 may not include the grids 308 and hence may not be configured to secure the motorized tiles 102. In some aspects, the tray 404 may be configured to secure special bins or packages that may be of irregular sizes, and hence may not fit into standard small, medium or large sized grids/motorized tiles.

Furthermore, although FIG. 2 depicts an aspect where the container 200 includes three slots 216 and corresponding three first power and data interfaces 214, the present disclosure is not limited to the example arrangement shown in FIG. 2. In some aspects, the container 200 may include more than three slots 216 (e.g., six, eight, ten, etc. slots at different heights above the base 202) to enable the user to attach the frame 300 at any height desired by the user. In this case, the first power and data interfaces 214 may be movable along a container height to enable the user to move the first power and data interface 214 to any desired height and conveniently attach the interface with the frame 300.

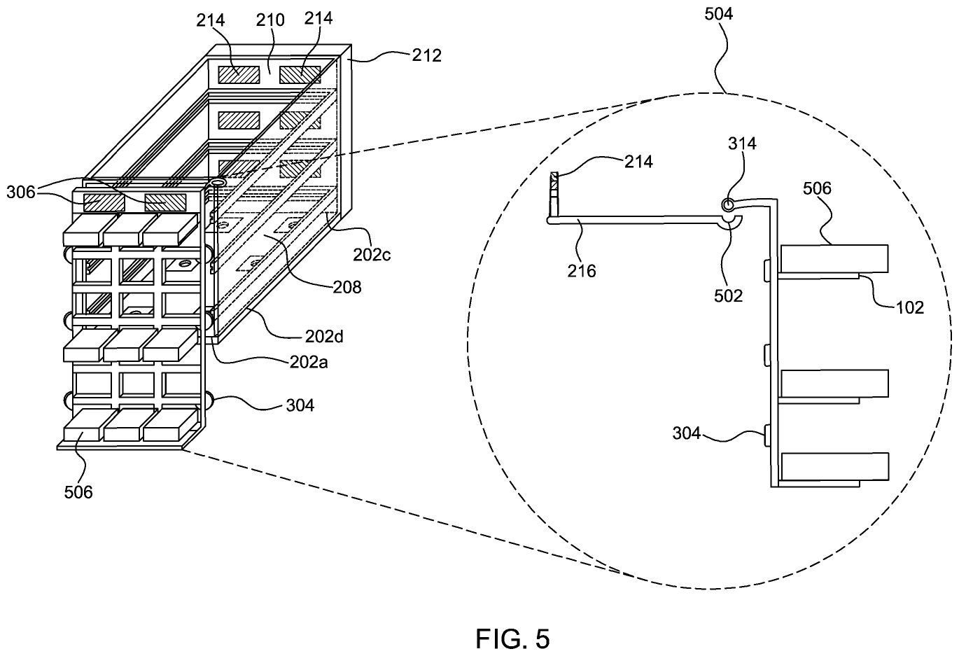

In additional aspects, the frame 300 may include one or more caster wheels or hinge interfaces 314 that may be disposed on the third frame edge 302c. In some aspects, the hinge interfaces 314 may be disposed at the intersection points of the third frame edge 302c with the second and fourth frame edges 302b, 302d. The hinge interface 314 may be configured to engage with a groove 502 that may be disposed at a slot end to enable the frame 300 to axially rotate relative to a slot longitudinal axis. An example engagement between the hinge interface 314 and the groove 502 is depicted in view 504 of FIG. 5.

In some aspects, the groove 502 may be part of the slot 216 and may be disposed at the slot end that may be in proximity to a vehicle exit door (or container exit door) and away from the back wall 210. In an exemplary aspect, the groove 502 may be disposed at the slot 216 that may be disposed at the height “H3” above the base 202. Stated another way, the groove 502 may be disposed at the slot 216 that may be disposed farthest away from the base 202. In other aspects, the groove 502 may be disposed in any of the slots 216.

In some aspects, the frame 300 may be configured to slide out from the slot 216 via the rollers 304 (e.g., when the user slides the frame 300 out) and axially rotate from a first position to a second position relative to the slot longitudinal axis via the hinge interface 314 and the groove 502. In some aspects, a plane of the frame 300 (or “frame plane”) may be parallel to the base plane when the frame 300 may be in the first position (as shown in FIG. 4), and may be perpendicular to the base plane when the frame 300 may be in the second position (as shown in FIG. 5).

When the user slides out the frame 300, the hinge interface 314 and the groove 502 may “snap” into each other, enabling the user to axially rotate the frame 300 from the first position (i.e., a horizontal or lateral position) to the second position (i.e., a vertical position). In some aspects, when the frame 300 may be moved from the first position to the second position, respective grids 308 may enable the motorized tiles 102 to rotate to be parallel to ground (e.g., tile plane may be parallel to the ground or the base plane), so that bins/packages 506 placed on the motorized tiles 102 may not slip.

A person ordinarily skilled in the art may appreciate that in the vertical position (i.e., in the second position), bin loading/unloading to/from the frame 300 may be convenient for the user. When the user may have finished bin loading/unloading, the user may disengage the hinge interface 314 from the groove 502, and may slide the frame 300 back into the slot 216 to move the frame 300 to the first position (i.e., the horizontal position).

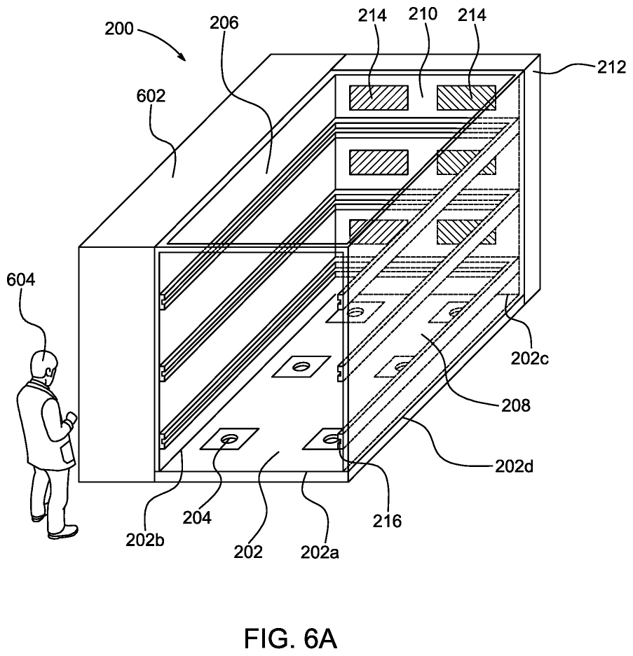

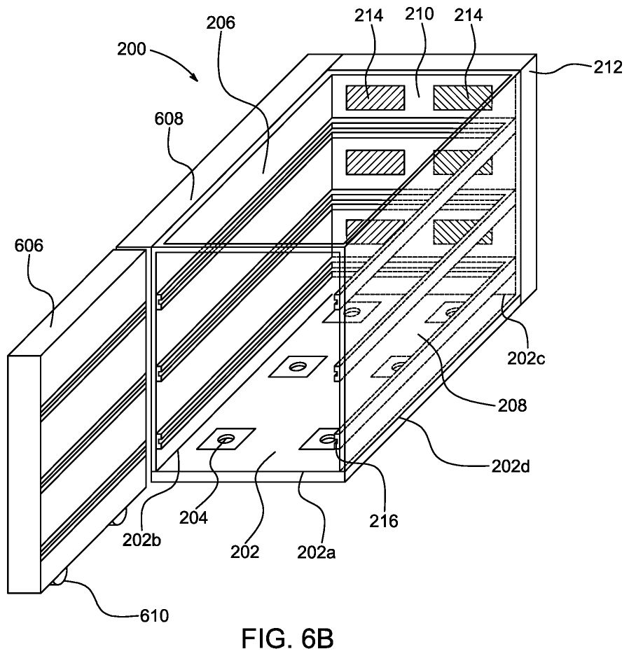

As described above, the user may customize container dimensions based on user requirements. For example, the user may customize the container dimensions such that the container 200 may occupy/fill an entire volume of the vehicle cargo space. In other aspects, the user may customize the container dimensions such that the container 200 occupies a portion of the cargo space volume (e.g., 60-80% volume), leaving some space open/vacant at a vehicle cargo space top portion or bottom portion. In yet another aspect, the user may customize the container dimensions such that the container 200 occupies a portion of the cargo space volume, leaving some space open/vacant at the vehicle cargo space right portion or left portion, as shown in FIG. 6A. As shown in FIG. 6A, the container 200 may not occupy a space 602. A vehicle operator or user 604 may use the space 602 to place large-sized or irregular packages that may not be accommodated on the motorized tiles 102, or for any other application. The user 604 may also enter the space 602, if required, to load/unload packages.

In additional aspects, a vertical pullout drawer 606 may be attached to a space 608 (similar to the space 602 described above) that may be adjacent to the container 200 in the vehicle interior portion/cargo space, as shown in FIG. 6B. The user 604 may use the drawer 606 to store mails, tools, and/or the like. In some aspects, the drawer 606 may include rollers 610 that may be disposed at a drawer bottom portion to enable the user 604 to conveniently move the drawer 606 from a closed position to an open position (and vice-versa). In other aspects, the drawer 606 may not include the rollers 610.

Although the description above describes an aspect where the container 200 is removably attached to the vehicle 100, in some aspects, the container 200 may also be attached to a wall or surface of a warehouse or a parking lot, based on loading/unloading requirements.

FIG. 7 depicts a first example base 702 of a bin 700 in accordance with the present disclosure. The bin 700 may be same as the bin 110 described above in conjunction with FIG. 1. The bin 700 may be secured on the motorized tile 102 (not shown in FIG. 7) via the base 702. Specifically, a base bottom portion 704 may be secured on the motorized tile 102.

In some aspects, the bin 700 and the base 702 may be an integrated structure formed of a single piece plastic (e.g., via injection molding or other known manufacturing processes). The bin 700 and the base 702 may be made of lightweight plastic so that the bin weight may be lesser than the weight of a conventional bin and base.

The base 702 may include V-shaped grooves 706 on base side portions/periphery, and the base bottom portion 704 may include geometric features 708 formed within the plastic of the base bottom portion 704. In some aspects, the geometric features 708 may be “tracks” or indentations (e.g., bumps or tread pattern) that may enable the base bottom portion 704 to conveniently move on the wheels 106, 108. Since the geometric features 708 are formed within the base plastic, the geometric features 708 do not wear or get torn when the geometric features 708 move on the wheels 106, 108. Further, the V-shaped grooves 706 may act as female attachment means for the gates 104 (that may act as male attachment means), when the base 702 moves past the gates 104 from one motorized tile 102 to another.

In some aspects, the geometric features 708 may be formed in recessed channels disposed on the base bottom portion 704. In further aspects, the base bottom portion 704 and the motorized tiles 102 may include magnetic materials that may enable secure magnetic coupling between the bin 700 and the motorized tiles 102. The magnetic coupling may prevent any unwanted bin movement on the motorized tiles 102.

FIG. 8 depicts a second example base 802 of a bin 800 in accordance with the present disclosure. The bin 800 may be same as the bin 110. In the exemplary aspect depicted in FIG. 8, the bin 800 and the base 802 may be separate from each other, and may not be integrated to form a single structure (as described above in conjunction with the bin 700 and the base 702).

The base 802 may include V-shaped grooves 804 that may be formed on base side portions/periphery. The V-shaped grooves 804 may be same as the V-shaped grooves 706 described above in conjunction with FIG. 7. In some aspects, the base 802 may further include sidewalls 806a, 806b, 806c and 806d (collectively referred to as sidewalls 806). The sidewalls 806 may define or form a cavity or an enclosure 808 in a base interior portion, into which a bin bottom portion may be inserted. Enclosure dimensions may be equivalent to bin bottom portion dimensions, which may enable a user to conveniently insert the bin 800 into the base 802. Responsive to the bin 800 being inserted into the base 802, the sidewalls 806 may secure the bin 800 in the base 802 and prevent any unwanted bin movement during transit (without requiring any bolts to be attached between the bin bottom portion and the base 802).

In some aspects, one or more sidewalls 806 may be configured to be folded onto the enclosure 808 or removed to accommodate joining of two adjacent bases (not shown) for a large bin or package.

In the exemplary aspect depicted in FIG. 8, the bin 800 and the base 802 may be made of different materials based on user requirements. Further, the base 802 may stay attached to the motorized tile 102 when the user or a robot unloads the bin 800 from the vehicle 100, and may then again insert the bin 800 to the base 802 during loading operation, thereby enabling quick bin unloading and loading.

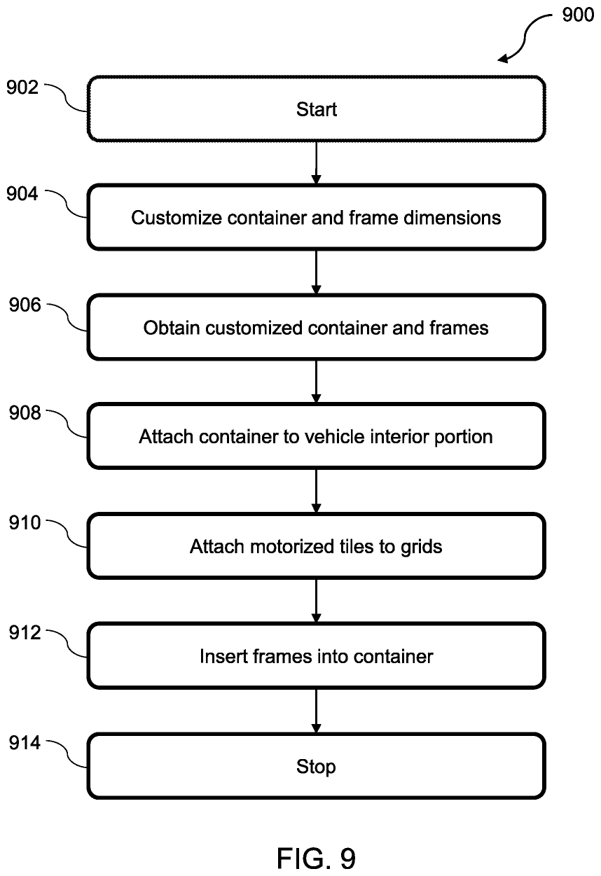

FIG. 9 depicts a flow diagram of a method 900 for installing the container 200 in the vehicle 100 in accordance with the present disclosure. FIG. 9 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 900 starts at step 902. At step 904, the method 900 may include customizing or ordering to customize dimensions of the container 200 and the frames 300 based on user requirements. At step 906, the method 900 may include obtaining the customized container and the frames. At step 908, the method 900 may include attaching the container 200 to the vehicle interior portion. For example, as described above, the container 200 may be attached to the vehicle cargo bed via the attachment mechanism 204.

At step 910, the method 900 may include attaching the motorized tile 102 to the grid 308. At step 912, the method 900 may include inserting the frames 300 into the slots 216/container 200. Responsive to inserting the frames 300 into the slots 216, the user or a robot may place/load the bins 110 on the motorized tiles 102.

The method 900 ends at step 914.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A container comprising:
a base;
a first sidewall, a second sidewall and a third sidewall, wherein each of the first sidewall, the second sidewall and the third sidewall is disposed perpendicular to the base;
a slot disposed on the first sidewall, the second sidewall and the third sidewall;
a first power and data interface disposed on the third sidewall; and
a frame configured to be removably inserted into the container via the slot, wherein the frame comprises:
a second power and data interface configured to couple with the first power and data interface; and
a plurality of grids configured to secure a plurality of motorized tiles.

2. The container of claim 1, wherein the container is configured to be removably attached to a vehicle cargo bed via the base.

3. The container of claim 2, wherein the first power and data interface is configured to couple with a vehicle power and data interface.

4. The container of claim 1, wherein each grid comprises a third power and data interface, and wherein the third power and data interface obtains power and data from the second power and data interface.

5. The container of claim 1, wherein the third sidewall is disposed perpendicular to the first sidewall and the second sidewall, and wherein the first sidewall and the second sidewall are parallel to each other.

6. The container of claim 5, wherein the slot is disposed along a first sidewall length, a second sidewall length and a third sidewall length, and wherein the slot is parallel to a base plane.

7. The container of claim 1, wherein the frame comprises a first edge, a second edge, a third edge and a fourth edge, wherein the first edge and the third edge are perpendicular to the second edge and the fourth edge, and wherein the first edge and the third edge are parallel to each other.

8. The container of claim 7, wherein the first edge and the third edge comprise one or more rollers that enable the frame to slide on the slot.

9. The container of claim 7, wherein at least one of the second edge, the first edge and the third edge comprises a hinge interface.

10. The container of claim 9, wherein the slot comprises a groove disposed at a slot end.

11. The container of claim 10, wherein the frame is configured to axially rotate from a first position to a second position relative to a slot longitudinal axis via the hinge interface and the groove.

12. The container of claim 11, wherein a frame plane is parallel to a base plane in the first position, and wherein the frame plane is perpendicular to the base plane in the second position.

13. A container comprising:
a base;
a first sidewall, a second sidewall and a third sidewall, wherein each of the first sidewall, the second sidewall and the third sidewall is disposed perpendicular to the base;
a slot disposed on the first sidewall, the second sidewall and the third sidewall, wherein the slot comprises a groove disposed at a slot end;
a first power and data interface disposed on the third sidewall; and
a frame configured to be removably inserted into the container via the slot, wherein the frame comprises:
a first edge, a second edge, a third edge and a fourth edge, wherein the first edge and the third edge are perpendicular to the second edge and the fourth edge, and wherein the first edge and the third edge are parallel to each other;
a hinge interface disposed on at least one of the second edge, the first edge and the third edge, wherein the frame is configured to axially rotate from a first position to a second position relative to a slot longitudinal axis via the hinge interface and the groove;
a second power and data interface configured to couple with the first power and data interface; and
a plurality of grids configured to secure a plurality of motorized tiles.

14. The container of claim 13, wherein a frame plane is parallel to a base plane in the first position, and wherein the frame plane is perpendicular to the base plane in the second position.

15. The container of claim 13, wherein the first edge and the third edge comprise one or more rollers that enable the frame to slide on the slot.

16. The container of claim 13, wherein the container is configured to be removably attached to a vehicle cargo bed via the base.

17. The container of claim 16, wherein the first power and data interface is configured to couple with a vehicle power and data interface.

18. The container of claim 13, wherein each grid comprises a third power and data interface, and wherein the third power and data interface obtains power and data from the second power and data interface.

19. The container of claim 13, wherein the third sidewall is disposed perpendicular to the first sidewall and the second sidewall, and wherein the first sidewall and the second sidewall are parallel to each other.

20. A vehicle comprising:
a vehicle cargo bed; and
a container configured to be removably attached to the vehicle cargo bed, wherein the container comprises:
a base;
a first sidewall, a second sidewall and a third sidewall, wherein each of the first sidewall, the second sidewall and the third sidewall is disposed perpendicular to the base;
a slot disposed on the first sidewall, the second sidewall and the third sidewall;
a first power and data interface disposed on the third sidewall; and
a frame configured to be removably inserted into the container via the slot, wherein the frame comprises:
a second power and data interface configured to couple with the first power and data interface; and
a plurality of grids configured to secure a plurality of motorized tiles.
